(19) United States
(12) Patent Application Publication
(10) Pub. No.: US 2025/0001312 A1
(43) Pub. Date: Jan. 2, 2025

(54) CROWDSOURCED CLOUD GAMING

(71) Applicants: Advanced Micro Devices, Inc., Santa Clara, CA (US); ATI Technologies ULC, Markham (CA)

(72) Inventors: Le Zhang, Markham (CA); Wei Liang, Markham (CA); Ilia Blank, Markham (CA); Patrick Pak Kin Fok, Markham (CA); Eleftherios Makedon, Markham (CA); Amir Alam, Markham (CA); Sebastian Borkowski, Oshawa (CA); Goverdhan Aligeti, Hyderabad (IN)

(21) Appl. No.: 18/346,096

(22) Filed: Jun. 30, 2023

(51) Int. Cl. A63F 13/77; A63F 13/335; A63F 13/35

(52) U.S. Cl. CPC A63F 13/77; A63F 13/335; A63F 13/35

(57) ABSTRACT

Systems and methods for crowdsourcing cloud application execution are described. An application system receives, from a client device, a first request to initiate an application session. The application system identifies a host device to fulfill the first request. The application system then initiates execution of the application session on the host device and generates, for the client device, a plurality of controls to control the application session executing on the host device. The host device is incentivized for each application session hosted.

### BACKGROUND

### Description of the Related Art

Traditional cloud applications, such as cloud gaming implementations, require significant server infrastructure investments to be made up front in order to ensure playable latencies and good availability of server instances. The deployment and maintenance of such an infrastructure is challenging and costly, particularly when the location of the user base is unknown in advance and may change over time. These costs are incurred even when the user base is low, making under-utilization even more costly.

Cloud service providers face a significant hurdle in maintaining expensive equipment in large data centers. In order to keep these facilities running smoothly, regular upgrades are necessary which may require significant time and money. To make the expenses more manageable, companies need a significant number of users to offset the costs. However, directly transferring the expenses to users can become unreasonably expensive and unsustainable for the service provider.

In view of the above, improved systems and methods for providing cloud-based services are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram illustrating one network implementation of an application system.

FIG. 2 is a block diagram illustrating one implementation of various components of the application system.

FIG. 3 is a block diagram illustrating one implementation of a session-restore for a saved application session.

FIG. 4 is a block diagram illustrating one implementation of process isolation for hosting an application session.

FIGS. 4A-4C illustrate specific implementations of process isolation for hosting an application session.

FIG. 5 is an exemplary method for hosting an application session on a host device using a peer-to-peer network.

FIG. 6 is an exemplary method for restoring a saved application session for a client device using a host device.

FIG. 7 is an exemplary block diagram illustrating a network implementation of an application system and one or more data centers for execution of cloud-based applications.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for crowdsourced cloud gaming are disclosed. Crowdsourced cloud applications, such as those to provide and support gaming, leverage end-users' consumer gaming resources to host remote application sessions. As disclosed, a collection of end-user machines replaces the infrastructure (such as servers and data centers) traditionally used for cloud implementations. Further, an application system is described that enables set up and teardown of an application environment on a host device. A prospective host device is provided with an option to use computing resources of the application system. In various implementations, the application system deploys application files and/or other resources that are used by the host for execution of an application session. Once a suitable host device is identified, a peer-to-peer remote streaming connection is created between the host device and a client device that is requesting execution of the application session. In an implementation, the client device is able to control the application session that is executing at the host device. Further, once the application session is terminated the files and data associated with the application session are removed from the host device. In some cases, data associated with a saved application can be stored (e.g., in a database) and later restored. For example, when a request for restoring the last saved application session is received from the client device, the application system can restore the application session using saved data at another suitable host device.

In an implementation, an “application session” as described herein refers to a period of time during which a user interacts with a software application or program. During such a session, a user may engage with the application performing various tasks or actions, e.g., via a user interface. According to the implementation, an application session can begin when the user starts the application or opens a particular instance of the application on a user device. During an application session, users can perform different actions such as inputting data, navigating through different screens or sections, executing commands, modifying settings, and accessing various features or functions provided by the application. The interaction of the user with the application can also generate session-related data, such as user preferences, temporary data, or the application's state. In an implementation, session duration can vary depending on the nature of the application and the user's objectives. For example, a session on a productivity application or game might last for hours, other sessions may last only minutes.

In one implementation, an application session can include gameplay. In order to participate in the gameplay, a player connects to a game server through a network connection, either on their personal computers, gaming consoles, or mobile devices. For example, the user can join a virtual environment or game world where they can interact with other players who are also connected to the same server. The gameplay session for that player begins when the player logs into the game and ends when they log out or disconnect from the server. In the description that follows, the terms “application session” and “session” are used interchangeably.

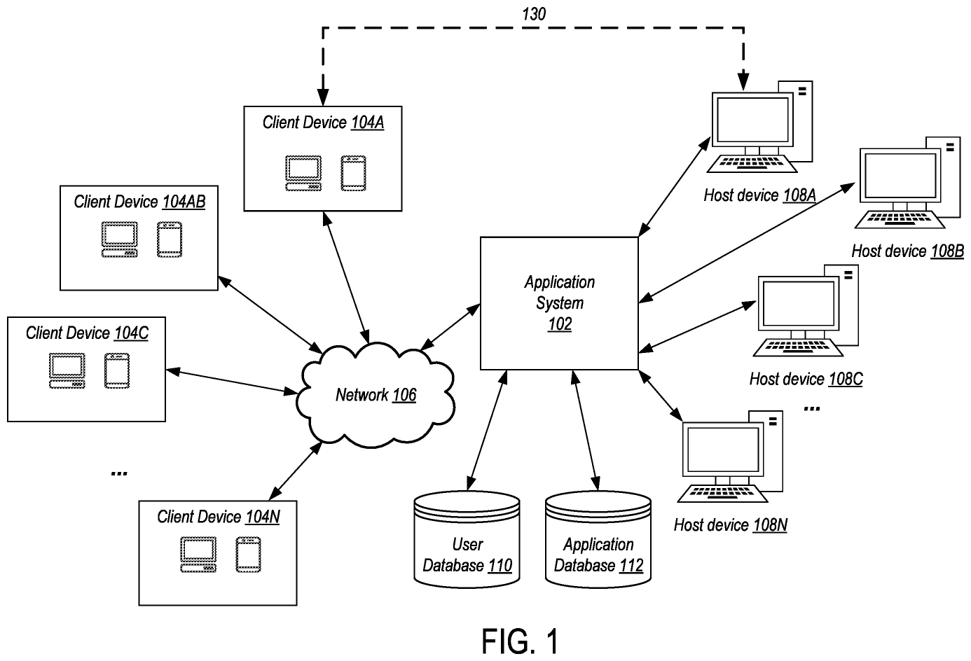

FIG. 1 is a block diagram illustrating an exemplary network implementation of an application system. As shown, a computing system 102 (alternatively referred to as application system 102) is connected to a plurality of client devices 104A-N (hereinafter also referred to as user devices 104A-N) over a network 106. In an implementation, the application system 102 is configured to identify a suitable host device from a plurality of host devices 108A-N, responsive to a request from a given user device 104, for execution of an application session. For example, the application system 102 can receive a request from a user device 104 for accessing a cloud gaming application. In response to receiving the request, the application system 102 is configured to identify a given host device 108, such that a requested session of the cloud gaming application can be hosted at the identified host device 108. Further, a peer-to-peer (P2P) connection between the user device 104 and the host device 108 is established to enable the client device to remotely engage with the application session. For example, as shown in the figure, a P2P connection 130 is established between host device 108A and user device 104A.

In an implementation, the host device 108 is identified as a suitable device for fulfilling a request from the user device 104, based on one or more factors. For example, the application system 102 is configured to measure end-to-end network performance metrics, such as available bandwidth and latency, associated with the host device 108 to ascertain whether host device 108 is able to execute the application session requested by the user device 104. In another example, the application system 102 is configured to determine a Network Address Translation (NAT) configuration for the user device 108, including but not limiting to, NAT Type (e.g., open, moderate, or restricted), nesting information, intermediate relay requirement (e.g., STUN or TURN), and the like. In yet another example, the application system 102 may rank host devices 108 based on a social credit or rating system. For example, each user device 108 can be incentivized for successful execution of application sessions and penalized for premature disconnections and session interruptions.

In one implementation, the application system 102 is configured to identify whether software associated with the requested application is determined to be available at the user device 108. Further, hardware specifications, e.g., game performance in terms of frames per second (FPS), can also be factored in during selection of the host device 108 for hosting the application session. In another implementation, the application system 102 can receive a predetermined hosting schedule from each user device 108 and select the given user device 108 based at least in part on its hosting schedule aligning with the user device 104 requirements of hosting the application session.

In an implementation, a given user device 104, is any device that is configured to communicate wirelessly and/or in a wired fashion with the application system 102 over a network, such as the network 106. In an example, the plurality of user devices 104A-N includes one or more of mobile devices, personal computers, laptops, gaming consoles, and the like. In another implementation, a user device 104 is configured to request the application system 102 for execution of a desired application, when the user device 104 is unable to host the application locally owing to lack of required infrastructure and/or computing resources.

For example, a user device 104 can send a request to application system 102 to connect with a cloud gaming application, to access a desired game title, that the user device 104 is unable to execute, e.g., owing to lack of adequate computing resources, such as but not limiting to, random access memory (RAM), graphics card, processor(s), operating system, and storage. Responsive to the request, the application system 102 identifies a user associated with the user device 104, by accessing user account information stored in a user data store, e.g., user database 110. The application system 102 validates the identified user to determine one or more game titles that the user device 104 is authorized to access. In an implementation, the application system 102 interacts with an application database 112 to determine the one or more game titles that the user device 104 is authorized to access. When it is determined that the user device 104 is authorized to access the game title, the application system 102 identifies a host device 108 to remotely host a session of the game title. Further, once such a host device 108 is identified, a network connection is established between the user device 104 and the host device 108, such that the user device 104 can remotely control the gameplay session running on the host device 108 using one or more user interfaces (not shown) generated at the user device 104.

In an implementation, if user information associated with the user device 104 is not found in the user database 110, the application system 102 may identify the user device 104 as an unregistered user device 104. When such an unregistered user device 104 is identified, the application system 102 is configured to send registration information that enables the user device 104 to register with the application system 102, e.g., in order to access one or more applications from the application database 112. The registration information, in one example, can include pricing information, required user information, registration validity, and the like. Once the user device 104 registers with the application system 102, the user device 102 can request the application system 102 for execution of one or more applications that the user device 104 registered for and/or register for other applications.

As described earlier, responsive to a request for execution of an application received from a given user device 104, the application system 102 identifies a host device 108 to fulfill said request. In an implementation, the host device 108 is identified as suitable for fulfilling the request, based at least in part on a plurality of computing resources found to be available with the host device 108. Referring back to the implementation of cloud gaming applications, a host device 108 is selected from the plurality of host devices 108A-N to execute a requested gameplay session, when computing resources such as adequate memory, storage, graphics, processing capabilities, etc. for executing the gameplay session are determined to be available at the host device 108. In one implementation, the plurality of host devices 108A-N includes personal computers such as gaming rigs and/or specialized computing devices to run high-performance applications. Other implementations are contemplated.

In one implementation, performance for a host device 108, especially for a determination whether the host device 108 is suitable for hosting a requested application session, is determined based at least in part on a set of application-specific performance metrics. In some examples, these metrics may include, frame rate, frame rate consistency, input latency (e.g., delay between local user input and screen rendition), streaming metrics, including network outbound bandwidth and network latency, encoding capabilities such as encoded frames per second, percentage of frame drops, etc. These metrics can be affected by the capability of hardware components, e.g., CPU, GPU, memory, storage I/O, network adapter, and the like for the host device 108. Further, these metrics are also be affected by factors such as virtualization overhead, compute load of other background tasks on the host device 108, network state between host device 108 and client device 104, ISP quality of service, etc. These and other contemplated metrics are factored by the application system 102 in a determining whether a host device 108 is enabled to host an application session and provide adequate performance while doing so.

In one implementation, the application system 102 is configured to generate an interface at the user device 104, such that the interface renders a plurality of controls to control the application session executing on the host device 108. When the user device 104 interacts with one or more controls rendered on the interface, the host device 108 detects the interaction, through the P2P connection 130, and modifies the application session based on the detected interaction. Doing so, the user device 104 is enabled to remotely interact with the application session hosted on the host device 108, as if it is being executed locally on the user device 104.

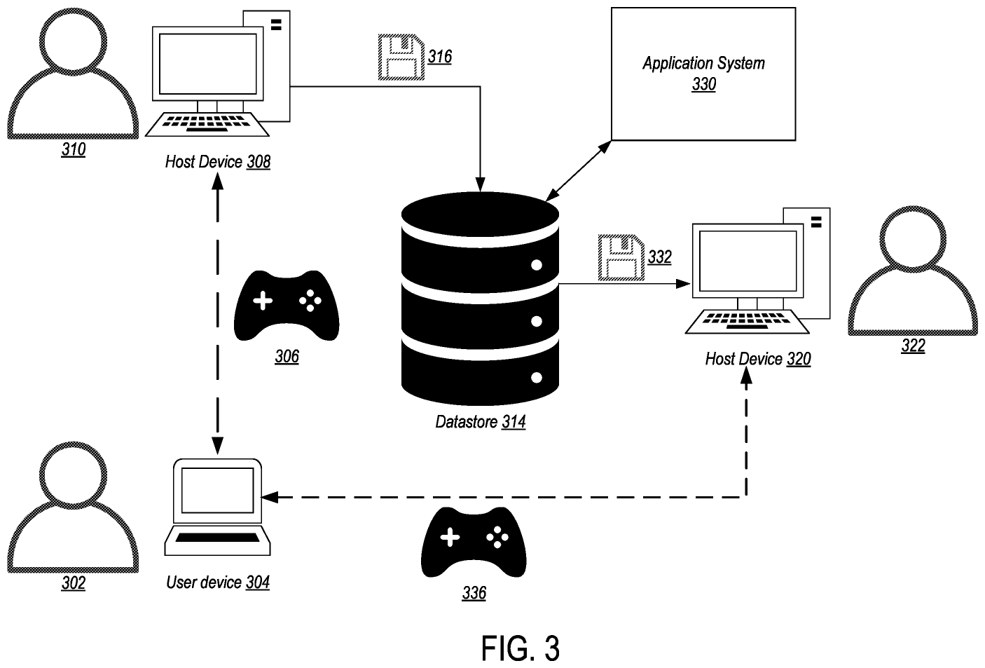

In another implementation, once an on-going application session hosted at a given host device 108 is terminated, the application system 102 is configured to extract application data, generated as a result of execution of the application session, from the host device 108. The application system 102 can store the application data in a specific data location, e.g., user database 110, wherein the application data is indicative of a last stored state of the application session. Further, responsive to a request received from a user device 104 to restore the application session from its last stored state, the application system 102 can identify another host device 108 to fulfill said request. Restoration of application sessions is further detailed in FIG. 3.

If more than one host device 108 is identified as candidates for hosting an application session, the application system 102 is configured to select a host device 108 geographically closest to the user device 104. In some cases, a given host device 108 may not have the necessary capacity/bandwidth to host the application or may be overused. In such cases, the application system 102 continues to search for a suitable host device 108 closest to the geo location of the user device 104, till a predetermined period of time has elapsed. The geo location of the user may be determined through various mechanisms such as GPS, IP address, and ping information. In one implementation, once selected, the application system 102 sends a signal to the selected host device 108 to pre-load the requested application in order to minimize latency during user device 104 interaction with the application.

In an implementation, each host device 108 that hosts an application session is incentivized based at least in part on number of application sessions determined to be successfully hosted. A successfully hosted application session, in an example, may be defined as an application session hosted within a predetermined limit of latency and without any disconnections. According to the implementation, a given host device 108 is prioritized for selection to host future application sessions, based at least in part on, the number of application sessions successfully hosted. In another implementation, in order to incentivize the host device 108, the application system 102 is configured to provide rewards to the host device 108, such as but not limiting to, discount coupons, monetary rewards, free subscriptions, and the like. In an implementation, account-based virtual currency and/or blockchain-based smart contracts can be accrued and redeemed for both monetary and in-kind rewards for the host device 108. For example, these rewards can include transferrable play time on the cloud gaming service as a client, discount for purchases of products, exclusive early access to new product releases, exclusive badges or cosmetic assets for social media, and the like.

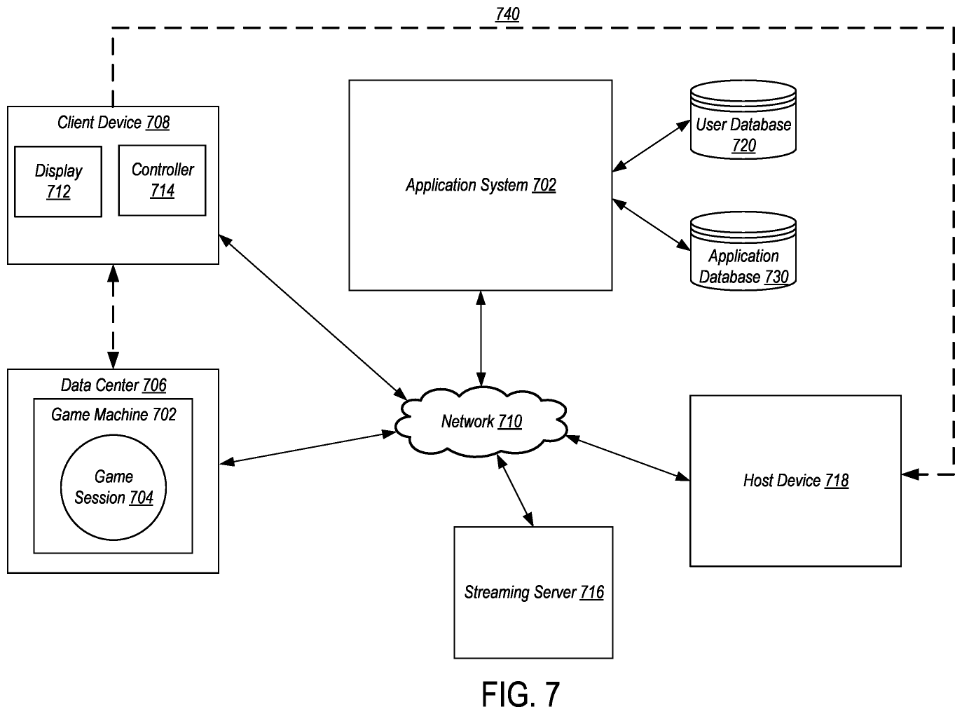

In an implementation, the host devices 108 are used to remotely host application sessions, as a replacement for server farms and data centers required in traditional cloud-based applications. Cloud-based applications, especially cloud gaming, necessitate substantial infrastructure to function properly, including data centers and server farms to run games, as well as high-speed internet connections with minimal latency to transmit gameplay streams to users. This infrastructure may not be available or accessible to consumers, making cloud gaming unfeasible and costly in most areas. Further, latency is a key factor that impacts the quality of cloud gaming services, as it can affect gameplay by introducing delays between user inputs and their effects, especially in fast-paced games that rely on precise inputs. Therefore, replacing the data centers and server farms with host devices as described above, can provide requesting user devices with quality seamless experience in their gameplay, without having to invest in expensive specialized hardware and software. Further, crowdsourcing remote gaming infrastructure can also reduce a service provider's infrastructure cost, offloading it to end-users who agree to become remote hosts. Even when accounting for the cost of incentives for these host devices, the solutions presented herein give the service provider a more flexible alternative to traditional cloud gaming implementations. Good performance may be achievable without a high investment in first-party servers if the population of crowdsourced hosts and clients are co-located. These solutions can also be used in concert with a traditional cloud gaming service deployment in order to provide a buffer or stop-gap, while adjustment to cloud infrastructure deployment is made to address shifting geographic locations of the user base (as detailed in FIG. 7).

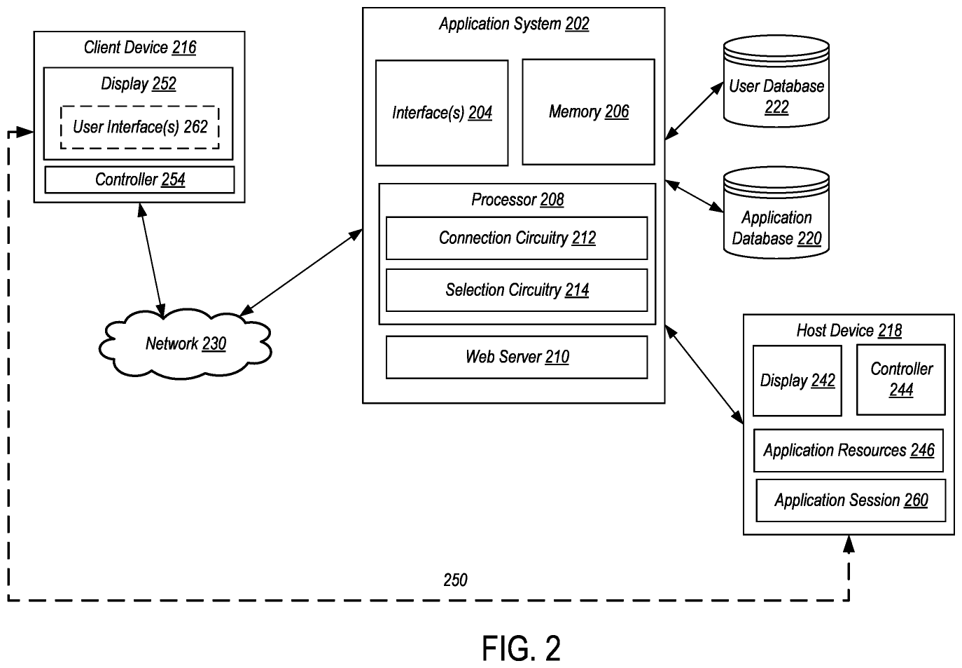

Turning now to FIG. 2, a block diagram of an exemplary implementation of various components of an application system 202 is illustrated. As shown in the figure, the application system 202 comprises one or more interface(s) 204, a memory 206, a processor 208, and a web server(s) 210. In an implementation, the one or more user interface(s) 204 are configured to display data generated as a result of the processor 208 executing one or more programming instructions stored in the memory 206. In one implementation, the processor 208 includes multiple cores configured to execute instructions. In some implementations, the processor 208 further includes circuitry configured to perform parallel processing. In some implementation, the processor 208 is a system on a chip (SOC) including multiple hardware components (e.g., CPU, GPU, memory controller, etc.). Multiple such implementations are possible and are contemplated. For instance, as shown, the processor 208 includes connection circuitry 212 and selection circuitry 214, in order to perform one or more functions described herein.

In an implementation, the connection circuitry 212 receives a request from a client device 216, for execution of an application. According to the implementation, the client device 216 can request the application system 202 for execution of a given application, when the client device 216 does not have the computing resources to execute the application locally. The request is received by the application system 202 over a network 230, such as Internet. For example, the client device 216 can request the application system 202 to access a cloud gaming site to run one or more games requiring hardware and software infrastructure to operate, that are unavailable to the client device 216 locally. The required hardware and software infrastructure can include RAM capacity, storage capacity, processing power, operating system capabilities, and the like.

In an implementation, responsive to receiving the request to execute the application from the client device 216, the connection circuitry 212 can determine whether the client device 216 is authorized to access the requested application. In an example, client devices registered with the application system 202 may have access to one or more applications, stored in the application database 220. In an implementation, the web server 210 processes the requests received from one or more client devices, such as the client device 216, over the network 230. In some implementations, the web server 210 processes requests to access one or more applications and responds to those requests, for example, by facilitating authorization of login credentials for the client device 216. In one example, for cloud gaming applications, web server 210 provides access to one or more user interfaces, which can take the form of one or more webpages when the client device 216 is accessing the application system 202 through a web browser. Further, the web server 210 is configured to access user data stored in the user database 222 in order to provide these services. The user data, in one example, comprises of information such as but not limiting to, username, password, registration date, email address, phone number, subscription ID, application usage history, social graph information, application ownership, preferences, and other settings. However, if the client device 216 is unregistered, the connection circuitry 212 provides an option to register to the client device 216. A user of the client device 216 can enter required registration information and register the client device 216. In an implementation, identification of whether a client device is a registered or unregistered device may be made by the connection circuitry 212, at least based in part on user data stored at user database 222.

Once the client device 216 is determined to be a registered device, e.g., authorized by the web server 210 (or an unregistered client device completes registration), the selection circuitry 214 identifies a suitable host device 218 to execute the application selected by the client device 216. In an implementation, the selection circuitry 214 identifies the host device 218 as suitable for hosting the requested application, based at least in part on whether the host device 218 has required computing resources to execute the application. For example, if the requested application is a cloud gaming application, a host device can be selected based on availability of computing resources, such as graphics processing capabilities, unavailable with the client device 216. In another implementation, the selection circuitry 214 is configured to select a given host device from a plurality of host devices based on previous application sessions successfully executed at the given host device. For example, the selection circuitry 214 can determine that the host device 218 has hosted the highest number of previously successful sessions for the selected application than other host devices. In yet another implementation, the host device 218 can also be selected based on its location proximity with the client device 216. For instance, the selection circuitry 214 can select the host device 218 when it is closest to the client device 216 based on the client device's geo-location. Other implementations, e.g., a combination of the above-described factors may be used to select a given host device, and these implementations are contemplated.

As shown in the figure, the host device 218 comprises of a display 242, a controller(s) 244, and one or more application resources 246. Similarly, the client device 216 comprises of a display 252 and controller(s) 254. In an implementation, the application system 202 creates a network connection, e.g., a peer-to-peer (P2P) connection 250 between the host device 218 and the client device 216. Using the P2P connection 250, the application session 260 hosted on the host device 218 can be controlled by the client device 216, as if the application session 260 is executing locally on the client device 216. In an implementation, the controller(s) 244 is configured to execute the session of the application using the one or more application resources 246, responsive to commands received from the controller(s) 254. Further, the output generated due to said execution is provided to the client device 216 by the host device 218 by rendering one or more user interfaces 262 onto the display 252 of the client device 216. As shown in the figure, the one or more user interfaces 262 is generated onto the display 252 of the client device 216, in real-time, enabling access to the application session through the client device 216.

In an example, for cloud gaming implementations, the host device 218 can execute a selected gameplay session and produces raw (uncompressed) video and audio. Video and audio are captured and encoded for streaming purposes by controller 244. In an implementation, encoding can provide compression of video and audio streams to reduce bandwidth usage and improve the gaming experience. Examples of encoding formats include H.265/MPEG-H, H.264/MPEG-4, H.263/MPEG-4, H.262/MPEG-2, WMV, VP6/7/8/9, etc. Encoded audio and encoded video are further packetized by controller 244 into network packets for transmission over the P2P connection 250. In some implementations, the host device 218 can further generate haptic feedback data, which can also be packaged into network packets for transmission to the client device 216.

In an implementation, the client device 216 decodes or reassembles audio packets, video packets, and haptic feedback packets to generate encoded audio, encoded video, and haptic feedback data. If the data is encrypted, the network packets are decrypted. The client device 216 then decodes the encoded audio and encoded video, as, to generate raw audio and video data for display on a display device 252. Haptic feedback data can be processed to create a haptic feedback effect on the controller device 254 or another haptic interface device. One example of a haptic effect is the vibration of the controller 254, such as a gaming controller.

As the application being hosted by the host device 218 responds to user inputs, therefore, a similar process to the above for transmitting and processing user input from the client device 216 to the host device 218 can be executed. In an example, input data is generated by a user operating the controller 254. This input data is packaged for transport to the host device 218 as input data packets. The host device 218 is configured to pack and reassemble these packets to define input data on the host device side, to update the application's state.

In an implementation, the application system 202 is configured to monitor the transmission quality for the P2P connection 250 to ensure the application's quality of service, during the transmission of various packets. Further, network conditions, such as upstream and downstream network bandwidth, can be monitored by the application system 202 and used to adjust the application execution, in response to changes in available bandwidth. In other words, encoding and decoding of network packets can be controlled based on current network conditions.

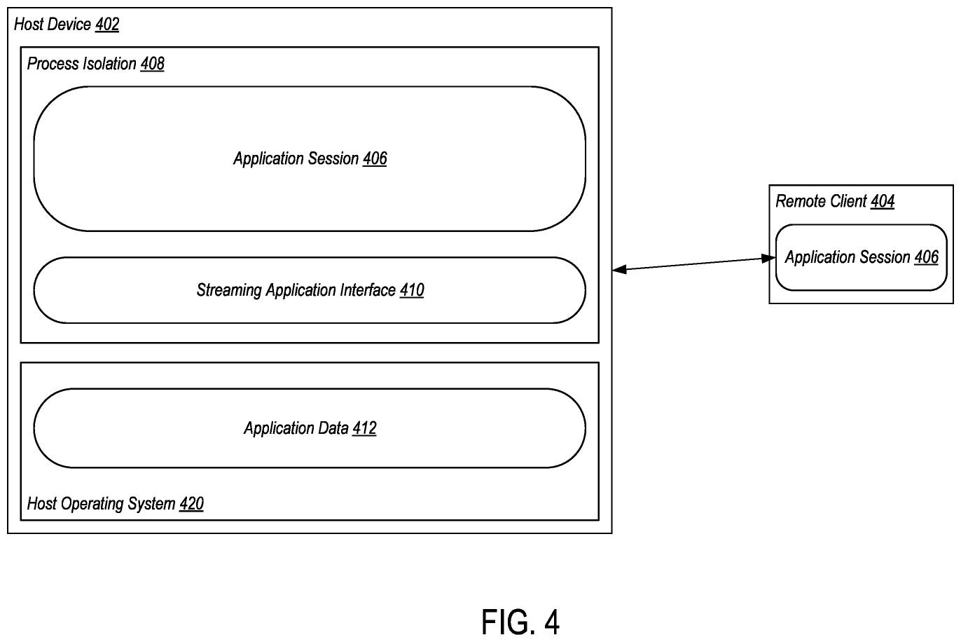

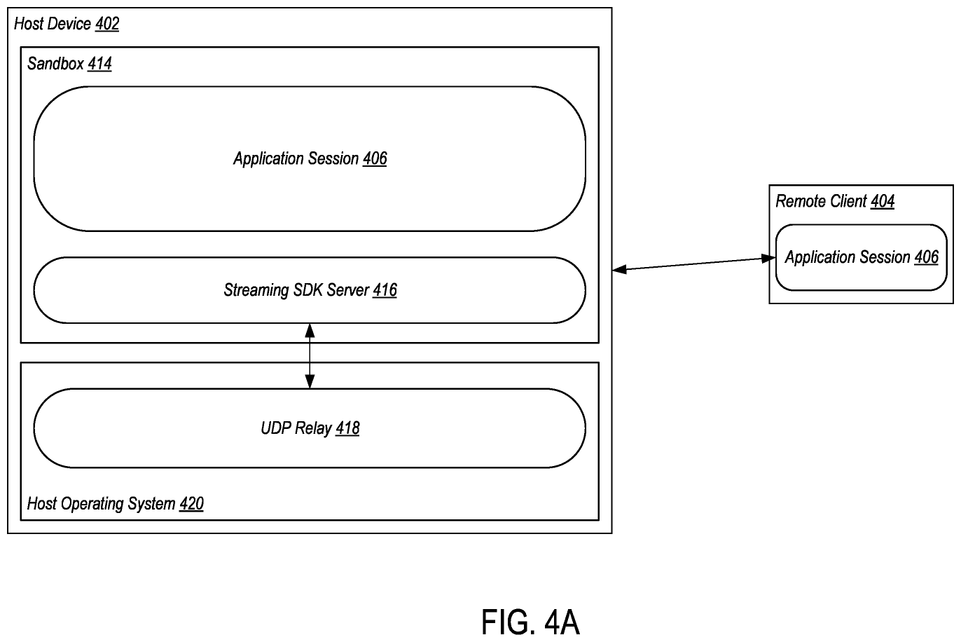

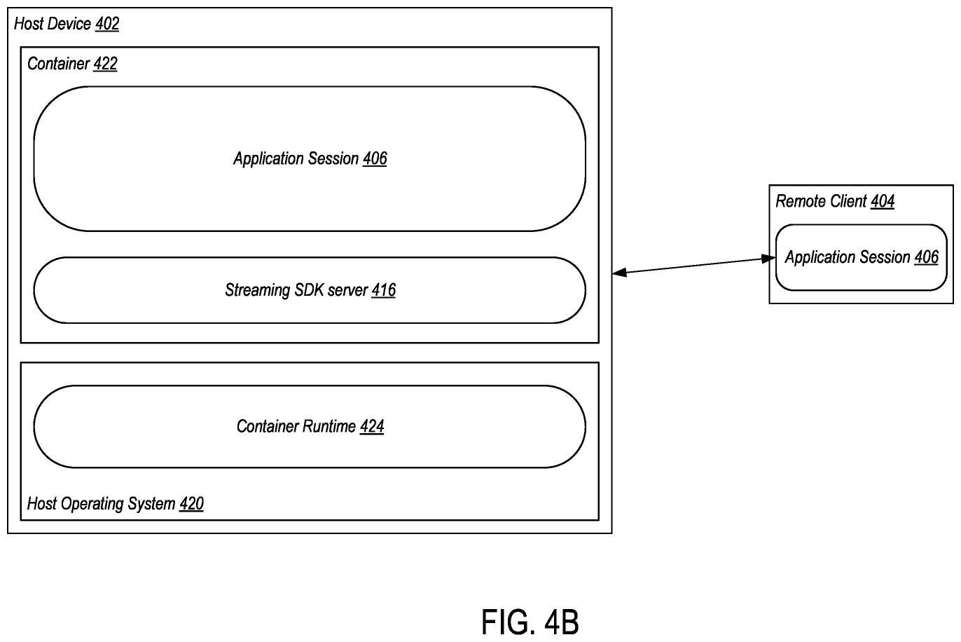

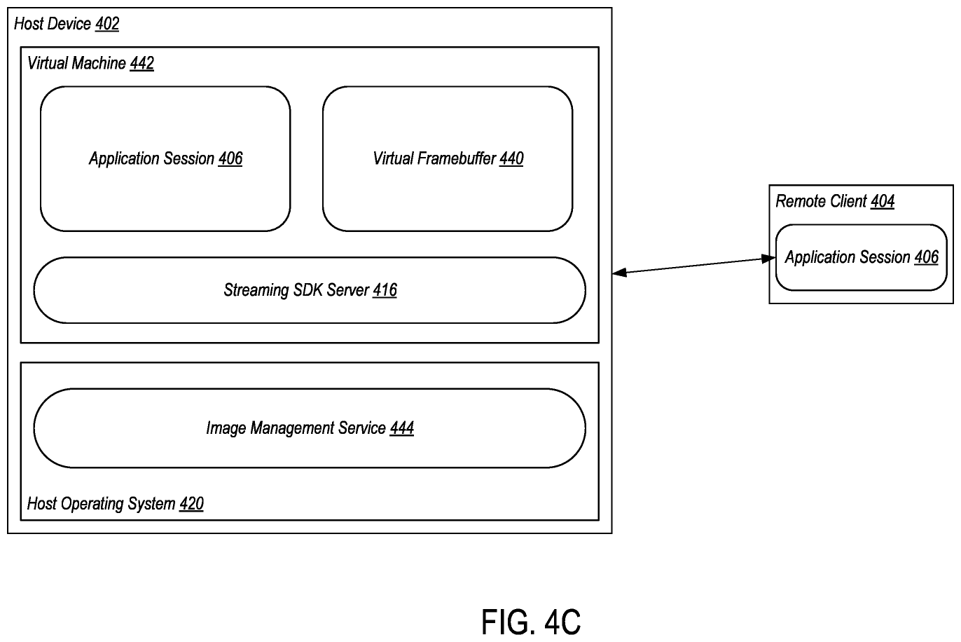

As the application session is terminated and/or the session completes execution, the application system 202 extracts all data, generated as a result of the execution of the application, from the host device 218 and stores the data in the user database 222. In one implementation, the application system 202 programs the host device 218 to host any given application in a manner that an end-user of the host device 218 is unable to interact with the application while it is running on the host device 218. This could be done to ensure that client device 216 privacy is maintained and unwanted changes to the application execution are avoided. The application system 202 can enable the host device 218 to host the application using one or more of containers or virtual machines, in a manner that the host device 218 can host the application in background, while local systems of the host device 218 can simultaneously operate without any modifications. This is further detailed in FIG. 4.

Referring now to FIG. 3, a block diagram illustrating exemplary implementation of a session-restore for a saved application session. As described in the foregoing, an application system (e.g., application system 330) selects a host device for hosting an application requested by a client device. The host device runs the application session using local computing resources and a network connection established between the client device and the host device enables the client device to control the application session locally. Once the application session is terminated, the application system 330 deletes all data generated during the execution of the application session and stores it in a datastore. Further, once the client device requests restoration of the application session, the application system 330 uses the saved data to restore the application session at another host device.

As depicted in FIG. 3, a user 302 using user device 304 is provided a peer-to-peer network connection for accessing one or more applications hosted at a first host device 308, belonging to another user 310. The P2P connection is symbolized using the “game controller icon” 306, as depicted in the figure. In an implementation, the one or more applications hosted at the host device 308 comprise of a cloud gaming application. Further, the peer-to-peer connection 306 enables the user device 304 to control a gameplay session of the gaming application, as it is being hosted at the host device 308. As the gameplay progresses, the host device 308 continues to provide local computing resources to ensure that the user device 304 is enabled to have control over the gameplay. In an implementation, the application system 330 is configured to monitor the P2P connection 306 between the devices to ensure that a desired quality of service is maintained.

Once the user 302 terminates the gameplay session, an indication from the user device 304 is transmitted to the application system 330. Responsive to receiving said request, the application system 330 extracts all application data generated as a result of execution of the gameplay session from the host device 308, and uploads said application data to a datastore 314. This is symbolized using the “save icon” 316, as depicted in the figure. In an implementation, the application data is indicative of the last saved state of the gameplay session. Further, the application data is uploaded to the datastore 314 and associated with user information previously stored for the user 302. In an example, the user information includes username, password, registration date, email address, phone number, subscription ID, application usage history, social graph information, application ownership, preferences, and other settings for the user 302.

In an implementation, if the user 302 wishes to restore the gameplay session from the last saved state, the user device 304 sends a request for restoration of the gameplay session to the application system 330. In one example, the restoration request is generated in response to the user 302 selecting a “restore last session” option, that is shown at a display of the user device 304. This option can be displayed in addition to one or more other options for accessing the gaming application, for example, each time the user device 304 reconnects with the application system 330. The other options may include options to start a new game, watch a previous gameplay session recording, change gameplay settings, view leaderboard, and the like.

The application system 330 is configured to select a second host device, e.g., host device 320 belonging to user 322, to host the restored application session. In an implementation, the host device 320 is selected from a plurality of host devices, based at least in part on a number of application sessions hosted by the host device 320 that are determined to be successful. In another implementation, the host device 320 can also be selected based on its geo-location proximity with the user device 304. In some implementations, a combination of these factors is used to select the host device 320.

In one implementation, the application session is restored from its last saved state to be hosted on the host device 320, using the application data saved to the datastore 314 as cross-referenced to the user information previously stored for the user 302. In other words, the application system 330 identifies relevant application data stored in the datastore 314 based on its association with the user information of the user 302. In cases where no such association is found, the application system 330 sends an error message to the user device 304. Cases where no association of saved application data with user information exists can occur due to improper termination of last session, user information being corrupted, user account validity being expired, and the like. Other implementations are contemplated.

When the last save state of the gameplay is identified using the application data, the application system 330 downloads the application data to the selected host device 320. This is referenced in the figure using “save icon” 332. Further, the application system 330 establishes a P2P connection (depicted by “game controller” icon 336). Using the P2P connection 336, the user device 304 can restore gameplay from the last saved state. Although FIG. 3 is described in relation to restoration of a gameplay session, in alternative implementations the described techniques may be used for any number of cloud-based applications. Such implementations are contemplated.

Turning now to FIG. 4, a plurality of implementations for executing an application on a host device are illustrated. As shown in FIG. 4, a host device 402 hosts an application session 406, requested by a client device 404. As described in the foregoing, the application session 406 is executed on the host device 402, using computing resources local to the host device 402. In an implementation, the application session 406 is hosted on the host device 402, in a manner that a user using the host device 402 is restricted to modify the application session, while it is being hosted. In an example, the user of the host device 402 is only able to switch off the host device 402 and is unable to interact with the application session 406 in any other manner.

In an implementation, in order to separate the application session 406 from other programs executing on the host device 402, a process isolation 408 is performed, such that the application session 406 is executed as a background process separate from the host operating system 420. As described with regards to FIGS. 4A-C, the process isolation 408 may be performed using one or more of a sandbox or containerization. Further, a user interface (e.g., streaming application interface 410) is generated, such that application data 412 is used to relay the application session 406 to the remote client device 404, as shown. In one implementation, the application data 412 is generated and used to stream the application session 406 to the remote client device 404, e.g., based on User Datagram Protocol (UDP), that is mainly utilized to establish connections between applications on the internet, with a focus on minimizing delays and being able to tolerate data loss. Other implementations are described with regards to FIGS. 4A-C.

Turning now to FIG. 4A, a sandbox 414 is used to isolate execution of the application session 406. In an implementation, the sandbox 414 allows users the host device 402 to run the application session 406 in a secure and isolated environment. For instance, using the sandbox 414, the host device 402 is enabled to create a temporary virtual machine, which can be discarded when the application session 406 is terminated. The sandbox 414 provides a safe way to host the application session, without risking modifications to the application session by the host operating system 420, when it is being executed. It is noted that, unless otherwise specified, similar reference numerals describe the same system components across the description for FIGS. 4A-C.

In an implementation, a software development kit (SDK) is used for building and deploying SDK servers 416, that enable real-time streaming of application data, generated as a result of execution of the application session 406, over a network, e.g., the internet. The streaming SDK server 416 provides tools and APIs to create and customize streaming data, e.g., including video and audio codecs, transcoding, and adaptive bitrate streaming. The server 416 can be integrated into a website or application, allowing remote client device 404 to access streaming media content in real-time.

In one implementation, a UDP relay 418 is used to forward or proxy UDP packets between two network endpoints, i.e., SDK server 416 and remote client device 404. This is typically done when there are network devices, such as firewalls or routers, that block or restrict UDP traffic between the two endpoints. The relay 418 receives the UDP packets from one endpoint, e.g., from the SDK server 416, and retransmits them to the other endpoint, i.e., remote client device 404, and vice versa. This technique can be used in various applications, including online gaming, VOIP, and multimedia streaming, where low latency and real-time data transmission are critical.

Turning now to FIG. 4B, a container 422 may be utilized to isolate the application session 406 hosted on the host device 402. In an implementation, container 422 enables software abstraction that bundles the application session's code and its dependencies into a single package. Unlike virtual machines (VMs), multiple containers can operate on the same machine, e.g., host device 402, and share the underlying operating system kernel with other containers, each executing in its isolated process in user space. In an implementation, a container runtime 424 is used to manage the operation of the container 422. A container runtime is a software component that enables the creation, management, and execution of containers. The container runtime 424, in one example, is responsible for starting and stopping the container 422, managing lifecycle of the container 422, and providing a user interface for interacting with the host operating system 420. The container runtime 424 uses a container engine (not shown), to package the application code and its dependencies into a container image, which can then be deployed and run on various container platforms. The container runtime 424 also provides security features, such as user and namespace isolation, to ensure that container 422 is isolated from other containers and from the host operating system 420.

FIG. 4C describes yet another implementation for process isolation of application session 406 using a virtual machine (VM) 442. In an implementation, the application session 406 running on the host device 402 renders associated video frames into the virtual framebuffer (VFB) 440. Further, streaming SDK server 416 reads from the VFB 440, encodes the video frames, and sends it out over a network (e.g., a peer-to-peer network connection) to the remote client 404. In one implementation, the image management service 444 is configured for application session 406 set-up and teardown; restoring and saving extracted data from the host device 402; managing configuration files, and the like. In alternate implementations, the VM 442 can be substituted with a container, such as Docker, so as to leverage out-of-the-box image management functionalities. To this end, the container may handle the software abstraction, instead of VM 442.

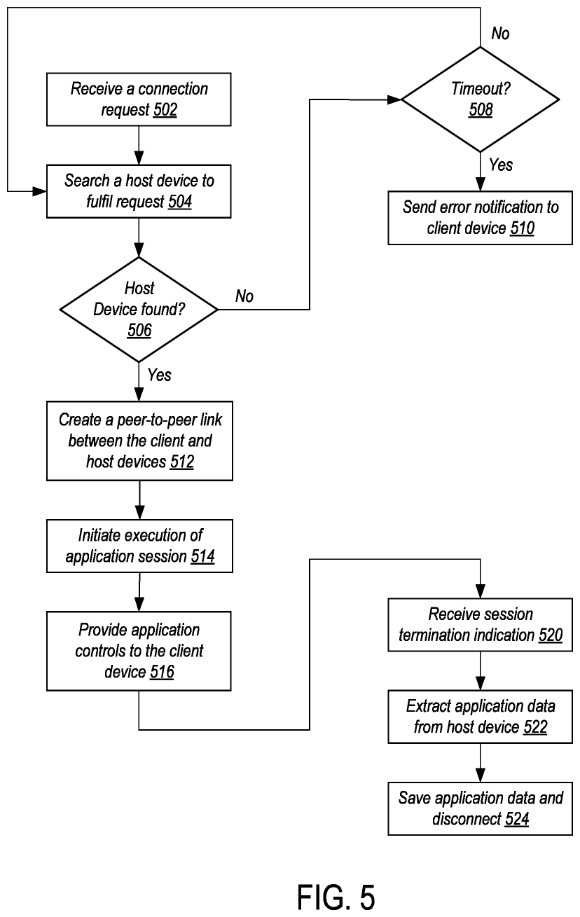

Turning now to FIG. 5, a method for hosting an application session on a host device using a peer-to-peer network is illustrated. As described in the foregoing a client device requests an application system for execution of a desired application session. The application system selects a host device to host the application session and creates a peer-to-peer (P2P) link between the client device and the host device. The client device is enabled to control the application session locally using the P2P link.

In an implementation, the application device receives a connection request from the client device (block 502). The connection request is indicative of a request to connect the client device to an application, such that the client device can interact with a session of the application. In an example, the application comprises of a cloud gaming site, and the connection request may be indicative of a request to execute a gameplay session of a selected game.

The application system, responsive to receiving the connection request, searches for a host device to fulfill the request (block 504). In an implementation, the host device is searched, based at least in part on successful application sessions previously by a given host device, geo-location proximity of the host device to the client device, and other factors. The application system then determines whether such a host device is found (conditional block 506). In case no such host device is identified, or an identified host device is unavailable (conditional block 506, “no” leg), the application system further determines whether a timeout period has been elapsed (conditional block 508). In an example, a timeout occurs when the application system fails to search for a host device within a specified time period after receiving the connection request. For example, if the application system is unable to process the connection request and respond within a set time limit, due to high traffic or overload conditions, a timeout error will occur. If the timeout period is elapsed (conditional block 508, “yes” leg), the application system sends a timeout error to the client device (block 510). Otherwise, the application system continues to search for a suitable host device (conditional block 508, “no” leg).

Once the host device is found (conditional block 506, “yes” leg), the application system creates a P2P link between the client device and the host device (block 512). Further, the application session is initiated to be hosted onto the host device (block 514). In an implementation, the application session is hosted on the host device in a manner that a user using the host device is restricted to view and/or modify the execution of the application session in any way. This is done using a virtual machine or container environment (as described in FIG. 4).

The application system provides a plurality of application controls to the client device as it is being hosted on the host device (block 516). In an implementation, the application system renders a user interface on a display of the client device and provides the plurality of controls over the user interface. The plurality of controls is provided to the client device such that the client device can access and control the application session locally, in real-time when it is hosted on the host device. Further, the output generated at the host device, responsive to the client device's interaction with the plurality of controls, is also relayed to the client device in real-time. This way, the client device can access the application as if it is being executed locally.

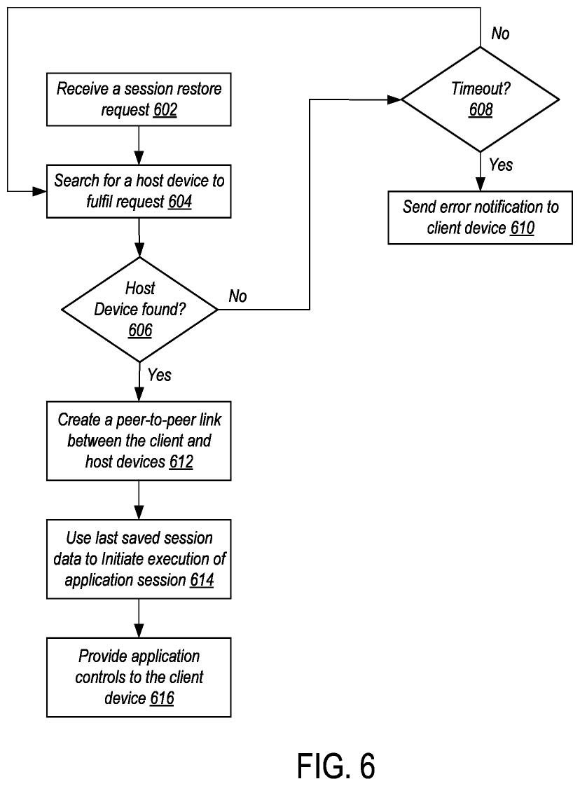

The client device can terminate the application session anytime during its execution. In an implementation, once the client device terminates the application session, an indication of termination of the application session is received by the application system (block 520). Responsive to receiving said indication, the application system extracts all data generated as a result of the execution of the application session from the host device (block 522). Further, the extracted data is saved in a datastore, and the P2P connection is disconnected (block 524). In one implementation, the extracted data is associated with user information previously of a user of the client device, wherein the user information is previously stored at the datastore. The association of the saved data with the user information is used to restore a saved application session, as described in FIGS. 3 and 6. In another implementation, the user information is also used to determine one or more applications that the client device is authorized to access.

FIG. 6 is an exemplary method for restoring a saved application session using a host device. In an implementation, once an application session being executed at a host device is terminated, an application system saves the state of the application session at the point of termination. This is herein referred to as last saved state of an application session. For example, if the application is a gaming application, the last saved state may be indicative of one or more of last level achieved, accumulated points at the point of termination, remaining turns at the point of termination, and the like. Once a client devices request restoration of the application session from its last saved state, the application system identifies a host device to restore the application system. The application system is then restored using previously saved data and user information.

As depicted in the figure, the application system receives a session restoration request from a client device (block 602). In an implementation, the session restoration request at least comprises a given termination point, at which the application session was previously terminated, from where the restoration is desired. Responsive to receiving the restoration request, the application system searches for a suitable host device to restore the application session (block 604). As described earlier, the host device is searched, based at least in part on successful application sessions previously by a given host device, geo-location proximity of the host device to the client device, and other factors.

The application system then determines whether such a host device is found (conditional block 606). In case no such host device is identified, or an identified host device is unavailable (conditional block 606, “no” leg), the application system further determines whether a timeout period has been elapsed (conditional block 608). In an example, a timeout may occur when the application system fails to search for a host device within a specified time period after receiving the restoration request. If the timeout period has elapsed (conditional block 608, “yes” leg), the application system sends a timeout error to the client device (block 610). Otherwise, the application system continues to search for a suitable host device (conditional block 608, “no” leg). Further, once the host device is found (conditional block 606, “yes” leg), the application system creates a P2P link between the client device and the host device (block 612).

The application system uses the saved application session data, as cross-referenced to previously stored user information associated with the client device, to restore the application system at the host device (block 614). The application system then provides a plurality of application controls to the client device (block 616), e.g., by rendering an interface on a display of the client device and providing the plurality of controls over the interface. In an implementation, based on settings and preferences dictated by the user information, the application system determines instructions for executing the restored application session. For example, when the application is a gaming application, every time a session is restored, the restored session may be executed in a single-player mode, until a multiple-player mode is activated. In another example, each time a session is restored, one or more controls may be defaulted based on pre-stored user preferences, until changes are made to the controls. Other implementations are contemplated.

FIG. 7 illustrates an exemplary implementation of a computing environment that enables multiple users to access a cloud video game over a network. As depicted, a game machine 702 executes a gameplay session 704. The game machine 702, in one implementation, can be located in a data center 706, alongside other similar machines that can execute cloud video gameplay sessions for different client devices. It should be noted that the game machine 702 can take different forms in various implementations, including a game console, bladed game console hardware, a server computer/blade, a virtual machine operating on hardware resources, or any other hardware setup that can provide an appropriate execution environment for the cloud video game.

In the illustrated implementation, the video gameplay session is defined for a primary client device 708. The gameplay session is streamed over a network 710, which may include the Internet, to the primary client device 708, associated with a given user. More specifically, the video gameplay session instantiates and maintains a game state that is updated based on received input commands. The game machine 702 renders video frames and audio based on the game state, defining a video stream (including both moving image data and audio data) that is transmitted over the network 710 to the primary user device. As used in the present disclosure, and unless noted or otherwise apparent from the disclosure, video shall refer to both moving image data and corresponding audio data. The client device 708 renders the video stream to a user interface (not shown) generated at a display 712 for viewing by the user. The user may interact with the video game through operation of a controller device 714, which can be any device through which the primary user can provide interactive input to the video game, such as a gaming controller, peripheral, keyboard, mouse, touchpad, trackball, motion controller, video camera, depth camera, microphone, etc.

In the implementation described above, the game machine 702 sends the video stream to the client device 708. In certain implementations, a streaming server 716 is employed to manage the streaming of the video stream to the client device 708. The streaming server 716 is configured to process the raw video output generated by the game machine 702, which may involve encoding it in a compressed format, transcoding it from one format/codec to another, or adjusting its bit rate based on various factors, e.g., network bandwidth, client device hardware capabilities, application/browser type of device, etc. to generate the video stream. In some implementations, the streaming server 716 is located in the data center 706, while in others, it may be situated in other locations such as other data centers. Additionally, in some implementations, the streaming server 716 is executed by the game machine 702.

In some implementations, in cases where the data center 706 and/or the streaming server 716 are overloaded, facing outages, or otherwise unavailable, to process the gaming application for the client device 708, the application system 702 is configured to identify a host device 718, in order to host the gaming application session for the client device 708. For example, the client device 708 can send a request to application system 702 to connect with the cloud gaming application, to access a desired game title. Responsive to the request, the application system 702 identifies the user associated with the client device 708, by accessing user account information stored in a user data store, e.g., user database 720. The application system 702 validates the identified user to determine whether the client device 708 is authorized to access the requested game title. In an implementation, the application system 702 interacts with an application database 730 to determine one or more game titles that the client device 708 is authorized to access. When it is determined that the game title requested by the client device 708 is authorized for access, the application system 708 initiates the host device 718 to remotely host a gameplay session for the game. Further, a network connection, e.g., P2P network connection 740, is established between the client device 708 and the host device 718, such that the client device 708 can remotely control the gameplay session running on the host device 718. In an implementation, the client device 708 can remotely control the gameplay session through the controller device 714.

In an implementation, using host devices in addition to data centers for hosting gameplay sessions can provide a buffer or “stop-gap” solution when host data centers and streaming servers are unavailable and adjustment to cloud infrastructure deployment is made. Further, the methods and systems described herein can also act as a solution to address shifting geographic locations of the client base, since repositioning traditional cloud gaming infrastructure in order to fulfill demand could be expensive for a service provider. Solutions presented herein may give the service provider a more flexible alternative to traditional cloud gaming implementations. Good performance may be achievable without a high investment in first-party servers if the population of crowdsourced hosts and cloud gaming clients are co-located. It is noteworthy that although FIG. 7 is described in regards with a gameplay session, in alternative implementations, the described techniques may be used for any number of cloud-based applications. Such implementations are contemplated.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by an application system from a first network-connected device, a first request to initiate an application session;
identifying, by the application system, a second network-connected device to fulfill the first request;
initiating, by the application system, execution of the application session on the second network-connected device; and
generating, by the application system for the first network-connected device, a plurality of controls to control the application session executing on the second network-connected device.

2. The method as claimed in claim 1, wherein the second network-connected device is identified from a plurality of host devices, and wherein identification of the second network-connected device is based at least in part on computing resources available at the second network-connected device.

3. The method as claimed in claim 1, further comprising:
responsive to a termination request to terminate execution of the application session, extracting application data generated during the execution of the application session, from the second network-connected device; and
saving the application data in a database.

4. The method as claimed in claim 3, further comprising:
receiving a second request, distinct from the first request, from the first network-connected device, the second request comprising a request to restore the application session;
identifying a third network-connected device to fulfill the second request; and
restoring, based at least in part on the application data, execution of the application session on the third network-connected device.

5. The method as claimed in claim 1, further comprising generating an interface at the second network-connected device, such that the interface renders the plurality of controls to control the application session executing on the second network-connected device.

6. The method as claimed in claim 1, further comprising identifying a number of application sessions hosted by the second network-connected device determined to be successful.

7. The method as claimed in claim 6, further comprising selecting the second network-connected device, from a plurality of host devices, for servicing one or more future requests for execution of application sessions, based at least in part on the number.

8. The method as claimed in claim 6, further comprising computing one or more rewards for the second network-connected device, at least based in part on the number of successful application sessions executed using the second network-connected device.

9. A system comprising:
a processor configured to:
receive, from a first network-connected device, a first request to initiate an application session;
identify a second network-connected device to fulfill the first request;
initiate execution of the application session on the second network-connected device; and
generate, for the first network-connected device, a plurality of controls to control the application session executing on the second network-connected device.

10. The system as claimed in claim 9, wherein the second network-connected device is identified from a plurality of host devices, and wherein identification of the second network-connected device is based at least in part on computing resources available at the second network-connected device.

11. The system as claimed in claim 9, wherein the processor is configured to:
responsive to a termination request to terminate execution of the application session, extract application data generated during the execution of the application session, from the second network-connected device; and
save the application data in a database.

12. The system as claimed in claim 11, wherein the processor is configured to:
receive a second request, distinct from the first request, from the first network-connected device, the second request comprising a request to restore the application session;
identify a third network-connected device to fulfill the second request; and
restore, based at least in part on the saved application data, execution of the application session on the third network-connected device.

13. The system as claimed in claim 9, wherein the processor is configured to generate an interface at the second network-connected device, such that the interface renders the plurality of controls to control the application session executing on the second network-connected device.

14. The system as claimed in claim 9, wherein the processor is configured to identify a number of application sessions hosted by the second network-connected device determined to be successful.

15. The system as claimed in claim 14, wherein the processor is configured to select the second network-connected device, from a plurality of host devices, for servicing one or more future requests for execution of application sessions, based at least in part on the number.

16. The system as claimed in claim 14, wherein the processor is configured to compute one or more rewards for the second network-connected device, at least based in part on the number of successful application sessions executed using the second network-connected device.

17. A computing system comprising:
at least one interface;
a memory; and
a processor configured to:
receive, from a first network-connected device, a first request to initiate an application session;
identify a second network-connected device to fulfill the first request;
initiate execution of the application session on the second network-connected device; and
generate, for the first network-connected device, a plurality of controls to control the application session executing on the second network-connected device.

18. The system as claimed in claim 17, wherein the second network-connected device is identified from a plurality of host devices, and wherein identification of the second network-connected device is based at least in part on computing resources available at the second network-connected device.

19. The system as claimed in claim 17, wherein the processor is configured to:
responsive to a termination request to terminate execution of the application session, extract application data generated during the execution of the application session, from the second network-connected device; and
save the application data in a database.

20. The system as claimed in claim 19, wherein the processor is configured to:
receive a second request, distinct from the first request, from the first network-connected device, the second request comprising a request to restore the application session;
identify a third network-connected device to fulfill the second request; and
restore, based at least in part on the saved application data, execution of the application session on the third network-connected device.
